(19) United States
(12) Patent Application Publication
(10) Pub. No.: US 2011/0250035 A1
(43) Pub. Date: Oct. 13, 2011

(54) FASTENER ASSEMBLY CONFIGURED FOR ATTACHING BOARD IN EXTERIOR WALL

(75) Inventors: Louise Franklin Goldberg, Minneapolis, MN (US); Mark Larry Stender, Chaska, MN (US)

(73) Assignee: MOISTURE MANAGEMENT, LLC, Chaska, MN (US)

(21) Appl. No.: 12/900,445

(22) Filed: Oct. 7, 2010

Related U.S. Application Data
(60) Provisional application No. 61/249,497, filed on Oct. 7, 2009.

(51) Int. Cl. E04B 1/38; F16B 25/10

(52) U.S. Cl. 411/366.1; 411/337

(57) ABSTRACT

A fastening system is configured for attaching a board that is spaced apart from a wall stud of an exterior wall. A stud cap is configured to be secured over an edge of the wall stud. A sleeve is configured to be secured to an exterior surface of the board, the sleeve defining a bore. A fastener comprises a shaft extending between a proximal end portion and a distal end, the proximal end portion comprising threads configured to couple with a surface of the bore of the sleeve and the shaft comprising threads configured to penetrate the stud cap and couple with the wall stud.

### CROSS REFERENCE TO RELATED APPLICATIONS

This Non-Provisional patent application claims priority to U.S. Provisional Patent Application Ser. No. 61/249,497, filed Oct. 7, 2009, which is incorporated by reference.

### BACKGROUND

One approach to fabricating a highly energy-efficient exterior wall assembly is to erect a wall frame supporting multiple layers of insulation placed between interior and exterior layers of the wall. One or more vapor permeable membranes (e.g. spun, bonded polyolefin or 60-minute Grade D building paper) is secured (e.g., stapled) to an exterior sheathing surface to prevent bulk water from wetting the insulation. Exterior cladding is attached over the vapor permeable membranes and the sheathing to protect the sheathing and for aesthetic affect. Exterior wall assemblies have a tendency to bulge out and almost always need to be drawn in to a uniform thickness.

Additionally, exterior wall assemblies have the potential to deform under loading. For example, wind forces acting on the exterior wall assembly can deflect the sheathing relative to the wall frame. Wall systems in which the insulation is located between the sheathing and the wall frame for moisture durability and energy efficiency reasons have a structural condition in which the sheathing is cantilevered relative to the frame. This cantilevering potentially creates stress concentrations at the fastener locations on the sheathing and the framing that can lead to structural failures of the wall system when subjected to cyclic service loading. These stress concentrations present challenges to the durability and longevity of energy-efficient exterior wall assemblies.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many intended advantages of embodiments will be readily appreciated as they become better understood by reference to the following detailed description. The elements of the drawings are not necessarily to scale relative to each other. Like reference numerals designate corresponding similar parts.

FIG. 1A is a front view and FIG. 1B is a top view of a fastening system employed to attach a board that is cantilevered from a wall stud of a wall according to one embodiment.

FIG. 2 is a cross-sectional view of the wall and the fastening system illustrated in FIG. 1B according to one embodiment.

FIG. 3A is a perspective view of a stud cap of the fastening system according to one embodiment.

FIG. 3B is a perspective view of a stud cap of the fastening system according to another embodiment.

FIG. 4A is an exploded cross-sectional view of a fastener assembly of the fastening system according to one embodiment.

FIG. 4B is a cross-sectional view of a fastener assembly according to one embodiment.

FIG. 5A is a cross-sectional view of a fastener assembly according to another embodiment.

FIG. 5B is a top view of a fastener assembly sleeve illustrated in FIG. 5A according to one embodiment.

### DETAILED DESCRIPTION

In the following Detailed Description, reference is made to the accompanying drawings, which form a part of this specification, and in which is illustrated specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration only and is in no way limiting. It is to be understood that other embodiments may be utilized and structural or logical changes may be made without departing from the scope of the disclosure, and that the features of the various exemplary embodiments described herein may be combined with each other, unless specifically noted otherwise. The following Detailed Description teaches exemplary embodiments that are not to be taken in a limiting sense. The scope is defined by the appended claims.

It is to be understood that the features of the various exemplary embodiments described herein may be combined with each other, unless specifically noted otherwise.

Embodiments provide a fastening system employed to attach a board that is cantilevered from a wall stud of a wall. A recent development in exterior wall assemblies includes a wall stud frame supporting a wall with insulative materials disposed between the wall studs and between an exterior sheathing and the wall studs. When attached, the exterior sheathing board is spaced away from the wall studs. Investigation by the undersigned inventors has determined that it is desirable to cantilever the sheathing board off of the wall studs according to the disclosed embodiments, which results in a rigid structural attachment of the board to the studs in a manner that does not damage or reduce the effectiveness of the insulation between the sheathing board and the wall studs.

Cantilevering a sheathing board away from the wall studs has the potential to give rise to undesirable stress concentrations at the wall studs and at the sheathing board. The stress concentrations have the potential to cause the wall assembly to fail when subjected to external loadings. Embodiments described herein provide a fastener assembly and a fastening system that enable the sheathing board to be rigidly cantilevered away from the wall studs and relieve the stress concentration at the wall studs and the sheathing board.

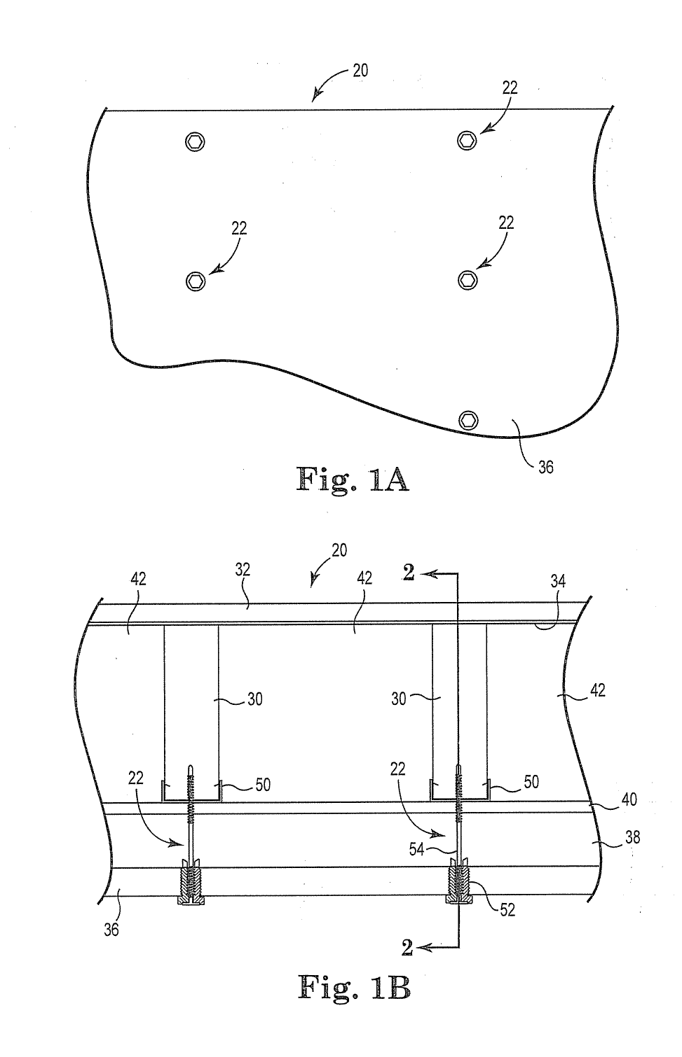

FIG. 1A is a front view and FIG. 1B is a top view of a wall assembly 20 including a fastening system 22 according to one embodiment. Wall assembly 20 includes wall studs 30 that support a vapor permeable membrane 34 between an interior wall layer 32 and wall stud 30, and a board 36 cantilevered from wall studs 30 and separated from wall studs 30 by insulation 38 and a moisture transport system 40 (MTS 40). In one embodiment, insulation 42 is inserted between wall studs 30.

In one embodiment, wall assembly 20 is similar to the wall assembly described in U.S. patent application Ser. No. 12/467,902 filed on May 18, 2009, which is herein incorporated by reference.

In one embodiment, fastening system 22 includes a stud cap 50 attached over and along an edge of each wall stud 30, a sleeve 52 communicating through board 36, and a fastener 54 extending through sleeve 52, board 36, insulation 38, MTS 40, stud cap 50, and secured within wall stud 30.

In one embodiment, fastening system 22 is configured to relieve the stress concentrations that can potentially arise along the edge of wall studs 30 and on the interior surface of board 36 when board 36 is attached and spaced apart from studs 30. In one embodiment, fastening system 22 is configured to rigidly secure board 36 relative to wall studs 30 in a manner that meets or exceeds the loading requirements of wall assemblies, as specified by the American Forest and Paper Association Wood Framing Manual. For example, in one embodiment, fastening system 22 attaches board 36 to wall studs 30 in a manner that configures wall assembly 20 to provide a minimum factor of safety of 1.15 with regard to the maximum allowable stresses of the wall assembly structural components.

In one embodiment, wall studs are wood 2×4 studs, although other materials such as metal or plastic/wood fiber composite studs, and other sizes, are also acceptable. In one embodiment, interior wall layer 32 is a finished surface interior wall formed of plaster board or like material, and permeable membrane 34 is an air and moisture vapor permeable sheet as commonly employed in home construction. In one embodiment, board 36 is provided as an oriented strand board, insulation 38 is 1.5 in. thick extruded polystyrene and insulation 42 is an unfaced fiberglass batt insulation (e.g. R-13 insulation value).

In one embodiment, MTS 40 is a polymer barrier sheet that forms a barrier to moisture transmission through MTS 40 by diffusion, capillary flow, hydrostatic flow or other penetration mechanisms. Moisture within wall assembly 20 will condense on MTS 40 barrier sheet, for at least the reason that the moisture is prevented from passing through MTS 40. In one embodiment, the moisture that condenses on MTS 40 is transported out of wall assembly 40 where the moisture is eventually evaporated. In one embodiment, MTS 40 is formed of a 10 mil polyethylene sheet.

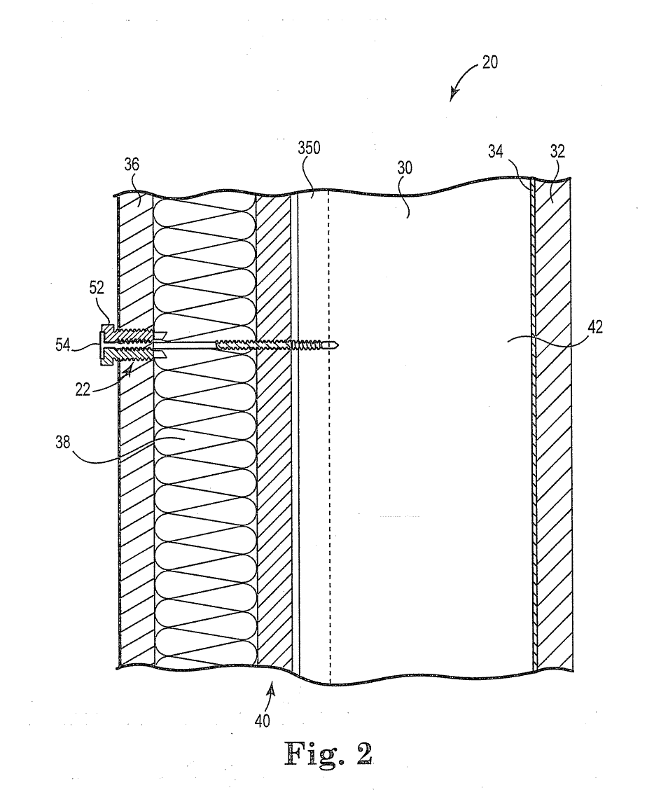

FIG. 2 is a cross-sectional view of wall assembly 20 including fastening system 22, according to one embodiment. Sleeve 52 has been inserted into board 36 and fastener 54 has been inserted into sleeve 52 and secured to stud 30. As illustrated, board 36 is cantilevered relative to stud 30. In one embodiment, fastener 54 is secured to stud 30 through stud cap 50 configured over stud 30. In one embodiment, sleeve 52 forms a through-opening through board 36 without damaging or forming a dimple in the exterior surface of board 36.

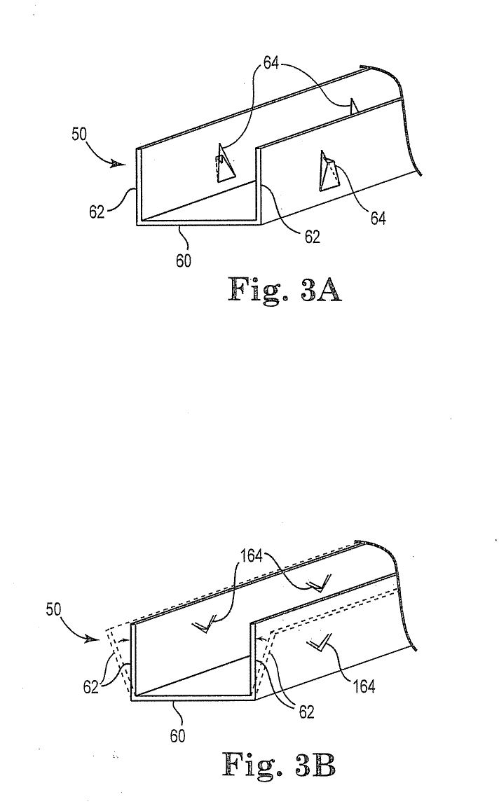

FIGS. 3A and 3B are perspective views of stud cap 50 of fastening system 22, according to embodiments. In one embodiment, stud cap 50 is provided as a C-shaped channel configured to be secured over an edge of wall stud 30 and includes legs 62 extending from a base 60. In one embodiment, stud cap 50 is formed of metal or of a material having a Young's modulus similar to a Young's modulus for metal (such as a reinforced polymer). Suitable materials for stud cap 50 include aluminum, steel, or reinforced polymers. In one embodiment, stud cap 50 is formed from galvanized steel sheet to form the C-shaped channel.

In one embodiment illustrated in FIG. 3A, legs 62 extend generally perpendicularly from base 60. In one embodiment, cleats 64 are formed to project to the exterior of the C-shaped channel of stud cap 50 and are bent or hammered into wall studs 30 upon installation. In one embodiment, cleats 64 are stamped out of legs 62 to form projections that positively attach stud cap 50 to the studs. In one embodiment, cleats 64 are triangularly shaped and project from the base of the triangular cut in a first direction away from the C-shaped channel for a first distance and then project in a second direction for a second distance such that the triangular tip projects towards the interior of the C-shaped channel.

In one embodiment illustrated in FIG. 3B, legs 62 are formed at an angle such that the distance between cleats 164 is the same as the width of the stud. In one embodiment, stud cap 50 is provided to be placed over studs 30 and legs 62 are hammered flush with the sides of the studs 30. In one embodiment, wall studs 30 are manufactured to include stud cap 50 attached along one edge. In one embodiment, stud cap 50 is provided separately from wall studs 30 (FIG. 1B) and attached to wall studs 30 at a construction site.

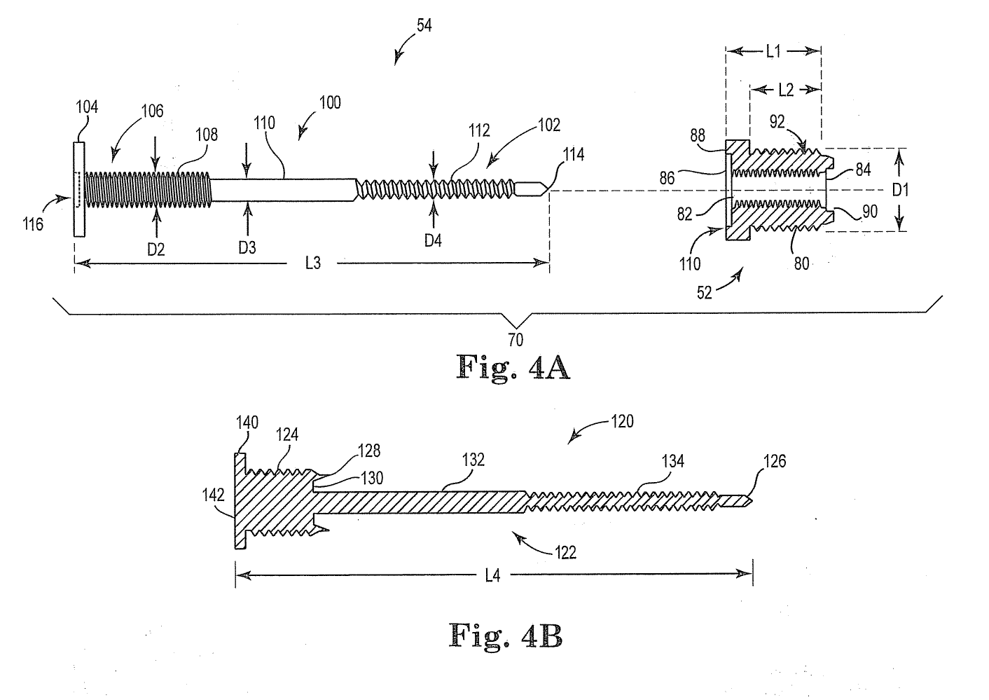

FIG. 4A is an exploded cross-sectional view of a fastener assembly 70 including a fastener 54 insertable into a sleeve 52 according to one embodiment.

In one embodiment, sleeve 52 includes a barrel 80 defining a bore 82 extending between a distal end 84 and a proximal end 86, and a flange 88 coupled to proximal end 86 of barrel 80. Barrel 80 is configured to penetrate a thickness of board 36 (FIG. 1B) and in one embodiment includes a self-drilling protrusion 90 extending from distal end 84. In one embodiment, sleeve 52 is configured to be secured to board 36 and includes a threaded exterior 92 extending between distal end 84 and flange 88. In one embodiment, bore 82 is provided as a cylindrical annulus extending between distal end 84 and proximal end 86. In one embodiment, bore 82 is threaded and configured to receive threads of fastener 54. In one embodiment, sleeve 52 has a diameter D1 of between approximately 0.7-1.0 inches, and preferably a diameter of about 0.78 inches. In one embodiment, sleeve 52 has a length L1 of between approximately 0.7-1.0 inches, and preferably sleeve 52 has a length L1 of approximately 0.59 inches. In one embodiment, barrel 80 has a length L2 of approximately 0.5 inches.

Fastener 54 includes a shaft 100 extending between a distal end portion 102 and a cap 104 attached to a proximal end portion 106. In one embodiment, shaft 100 includes threaded section 108 at the proximal end portion 106, an unthreaded shank 110, and a primary screw section 112 at the distal end portion. In one embodiment, distal end portion 102 includes a self-drilling tip 114 extending from the primary screw section 112 and configured to penetrate through metal stud cap 50 (FIG. 3A or 3B). In one embodiment, the threaded section 108 of shaft 100 includes progressive threads, National Pipe Thread (NPT) tapered thread, or other suitable thread configuration. In one embodiment, the primary screw section 112 at the distal end portion 102 is an external thread conforming to that of a deck screw in which the outer diameter D4 of the thread is greater than the outside diameter D3 of the unthreaded shank 110. In one embodiment, the inside diameter of the threaded primary screw section 112 is less than the outside diameter D3 of the unthreaded shank 110. In one embodiment, shaft 100 is provided as a partially threaded shaft and proximal end portion 106 is provided as a threaded cylindrical end portion configured to mate with annulus bore 82 of sleeve 52. In one embodiment, the inside diameter of the threaded section 108 is equal to the outside diameter D3 of the unthreaded shank 110. In one embodiment, the outside diameter D4 of the primary screw section 112 is just less than the outside diameter D2 of the threaded section 108, such that primary screw section 112 is fully passable through sleeve 52 without seizing. In one embodiment, fastener 54 has a length L3 of approximately 4 inches and a diameter D2 of approximately 0.2813 inches, although other dimensions are also acceptable. In one embodiment the unthreaded shank 110 separating the screw threads of the threaded section 108 and primary screw section 112 has a length of 0.75 inches.

Sleeve 52 is configured to be threaded into board 36 and includes, in one embodiment, a hex-driver or other suitable slot 110 for driving sleeve 52 into board 36. Fastener 54 is threaded through sleeve 52 and stud cap 50 and includes a suitable hex-head or other driver slot 116.

FIG. 4B is a cross-sectional view of a fastener assembly 120 according to one embodiment. Fastener assembly 120 includes a shaft 122 extending from a plug 124. In one embodiment, fastener shaft 122 is provided as an unthreaded shank 132 and a threaded section 134 including a self-drilling distal end tip 126. In one embodiment, plug 124 is provided as a threaded plug including a self-drilling protrusion 128 extending from face 130. Self-drilling tip 126 is configured to penetrate stud cap 50 (FIG. 3A or 3B) and self-drilling protrusion 128 is configured to form an opening in board 36 (FIG. 1B). In one embodiment the unthreaded shaft 132 separating the plug from the distal end thread 134 is 0.75 inches.

In one embodiment, plug 124 is provided with a flange 140 including a driver slot 142, for example a hex-head slot configured to receive a hex-head bit of a manual or powered driver. In one embodiment, fastener assembly 120 is provided as an integral one-piece fastener assembly having a length L4 of approximately 4 inches with dimensions of plug 124 similar to sleeve 52 (FIG. 4B).

With additional reference to FIG. 1B and FIG. 2, fastening system 22 is employed to rigidly cantilever board 36 relative to wall studs 30. For example, sleeve 52 is first inserted into board 36 and then fastener 54 is inserted into sleeve 52 and driven through stud cap 50 and into wall stud 30. In one embodiment, sleeves 52 are distributed along board 36 and aligned with studs 30 on 12 inch centers and fastener 54 is inserted about 1.5 inches into wall stud 30. In this manner, fastening system 22 rigidly secures board 36 to wall stud 30 in a manner that minimizes stress concentrations at stud 30 and board 36. For example, the stress concentration at wall stud 30 is minimized or alleviated by stud cap 50 and the stress concentration at board 36 is minimized or alleviated by sleeve 52.

With additional reference to FIG. 4A, in one embodiment barrel 80 is configured to couple with board 36 and flange 88 is configured to smoothly abut against board 36 in a manner that avoids causing a dimple or otherwise reducing the thickness of board 36. It is not desirable to reduce the thickness of board 36, as this has the potential to reduce one or more bending moments of inertia and weaken board 36.

Fastener assembly 70 (FIG. 4A) is selected to provide the rigid attachment of board 36 to wall stud 30 in a manner that minimizes the thermal circuit between wall stud 30 and board 36. For example, in one embodiment the overall diameter of fastener 54 is approximately 9/32 inches and configured to minimize the thermal conduction between wall stud 30 and board 36 by the fastener 54 that extends between these two components.

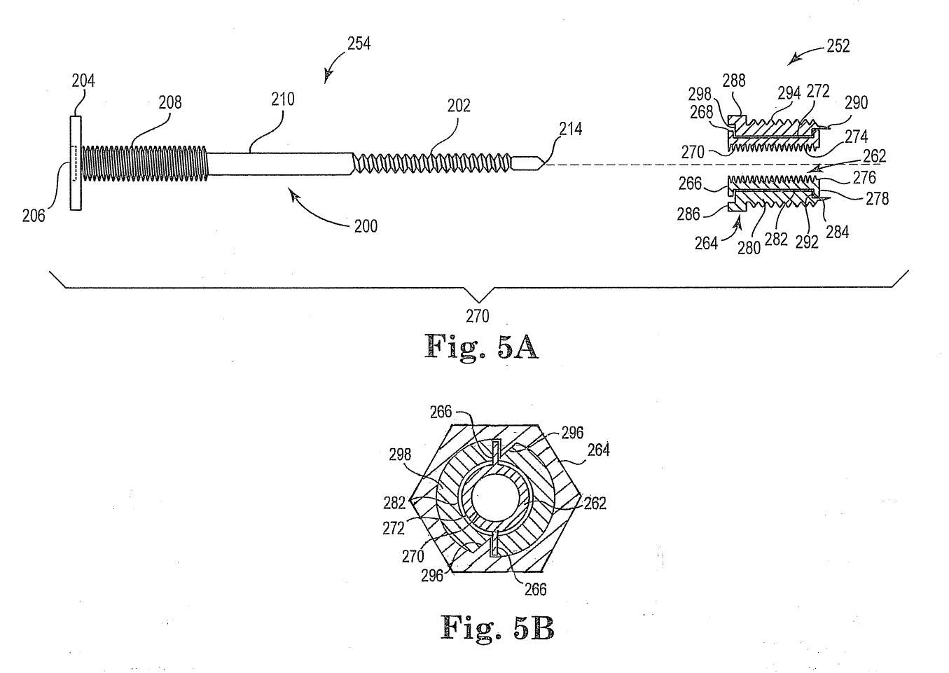

FIG. 5A is an exploded cross-sectional of a fastener assembly 270 of the fastening system according to one embodiment, including a fastener 254 insertable into a sleeve 252.

In one embodiment, sleeve 252 includes an inner bushing 262 and an outer bushing 264. The inner bushing 262 includes tabs 266 extending outwardly from a proximal end 268 of an inner bushing shaft 270. In one embodiment, inner bushing shaft 270 has a smooth exterior surface 272 and a threaded inner bore 274. In one embodiment, distal end 276 includes a flange 278 configured to position against seat 292 of outer bushing 262 when assembled. In one embodiment, the outer bushing 262 includes a barrel 280 defining a bore 282 extending between a distal end 284 and a proximal end 286, and a hub 288 coupled to proximal end 286 of barrel 280. In one embodiment, barrel 280 is configured to house the inner bushing shaft 270 of the inner bushing 262 which rotates within the barrel 280. In one embodiment, inner bushing 262 is assembled within the outer bushing 264 by inserting the inner bushing at the distal end 284 until the flange 278 abuts the seat 292. In one embodiment, tabs 266 are bent outward at the proximal end 268 to abut recess 298.

In one embodiment, bore 282 is provided as a cylindrical annulus extending between distal end 284 and proximal end 286. In one embodiment, bore 282 is threaded and configured to receive threads of fastener 254.

Similar to FIG. 4A, fastener 254 includes a shaft 200 extending between a distal tip 214 and a cap 206 attached to a proximal end portion 208. In one embodiment, distal tip 214 is a self-drilling tip configured to penetrate through metal stud cap 50 (FIG. 3A or 3B). In one embodiment, the proximal end portion 208 is threaded and includes progressive threads, National Pipe Thread (NPT) tapered thread, or other suitable thread configuration. In one embodiment, the threaded distal portion 202 is an external thread conforming to that of a deck screw in which the outer diameter of the thread is less than the inner diameter of the proximal end portion 208 threads. In one embodiment, inner diameter of the threaded distal portion 202 is equal to the outer diameter of the unthreaded shank 210 provided between the proximal end portion 208 and the threaded distal portion 202. The proximal end portion 208 is provided as a threaded cylindrical end portion configured to mate with inner bushing shaft 270.

In one embodiment, sleeve 252 is configured to be threaded into board 36 (FIG. 1B) and in one embodiment includes a self-drilling protrusion 290 extending from distal end 24. In one embodiment, sleeve 52 is configured to be secured to board 36 and includes a threaded exterior 294 extending between distal end 284 and flange 288. Fastener 254 is threaded through sleeve 252 and stud cap 50 and includes a suitable exterior hex-head or other driver profile 206.

As illustrated in the top view of sleeve 252 according to one embodiment of FIG. 5B, outer bushing 264 is configured to include stops 296 at the proximal end 286. In one embodiment, the inner bushing 262 rotates within the outer bushing 264 as the fastener 254 secures the insulation 38 (FIG. 1B) to the stud 30. In one embodiment, when cap 204 of the fastener 252 is seated against proximal end 286, tabs 266 are disengaged against stops 296 by shearing off, allowing inner bushing 262 to rotate freely within outer bushing 264. In one embodiment, the fastener 252 and inner bushing 262 continue to rotate within outer bushing 264 as the sheathing board 36 is tightly secured against insulation 38.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A fastening system configured for attaching a board that is spaced apart from a wall stud of an exterior wall, the fastening system comprising:
a stud cap configured to be secured over an edge of the wall stud;
a sleeve configured to be secured to an exterior surface of the board, the sleeve defining a bore; and
a fastener comprising a shaft extending between a proximal end portion and a distal end, the proximal end portion comprising threads configured to couple with a surface of the bore of the sleeve and the shaft comprising threads configured to penetrate the stud cap and couple with the wall stud.

2. The fastening system of claim 1, wherein the board is coupled to and cantilevered relative to the wall stud, and the sleeve is configured to relieve stress at an interface between the sleeve and the board and the stud cap is configured to relieve stress between the shaft and the wall stud.

3. The fastening system of claim 1, wherein the sleeve comprises a barrel configured to bore through a thickness of the board and a flange coupled to and extending laterally relative to a proximal end of the barrel.

4. The fastening system of claim 3, wherein a distal end of the barrel comprises a self-drilling protrusion configured to bore through the thickness of the board.

5. The fastening system of claim 3, wherein the flange is configured to mount flush against the exterior surface of the board and minimize deformation of the board.

6. The fastening system of claim 1, wherein the distal end of the shaft comprises a self-drilling tip configured to penetrate the board, the stud cap, and the wall stud.

7. The fastening system of claim 1, wherein the sleeve defines a threaded bore and the proximal end portion comprises a progressively threaded end portion that is configured to mate with the bore.

8. A fastener assembly configured for attaching a board in a cantilevered configuration relative to a wall stud of a wall, the fastener assembly comprising:
a sleeve comprising a barrel defining a threaded bore and a flange coupled to a proximal end of the barrel, the barrel configured to bore through a thickness of the board and the flange configured to abut an exterior surface of the board; and
a fastener comprising a shaft extending between a proximal end portion and a distal end, the proximal end portion comprising threads configured to thread into the threaded bore of the sleeve and the distal end of the shaft comprising threads configured to penetrate the wall stud.

9. A fastener assembly comprising:
a fastener comprising a shaft extending between a threaded proximal end terminating at a cap and a threaded distal end terminating at a tip, and an unthreaded shank between the threaded proximal end and the threaded distal end; and
a sleeve comprising an inner bushing and an outer bushing, wherein the inner bushing is configured to rotate within the outer bushing, the outer bushing comprising a flanged end and an opposing tapered end, the inner bushing defining a threaded annular bore configured to engage with the threaded proximal end of the fastener.

10. The fastener assembly of claim 9, wherein the inner bushing comprises at least one tab at proximal end configured to engage against at least one stop at the flanged end of the outer bushing.

11. The fastener assembly of claim 9, wherein an outer diameter of the threaded distal end is less than an outer diameter of the threaded proximal end.

12. The fastener assembly of claim 9, wherein the threaded proximal end and the threaded annular bore are configured with a first threaded configuration and the threaded distal end is configured with a second threaded configuration.

13. The fastener assembly of claim 10, wherein the at least one tab is configured to shear off from the inner bushing when the fastener cap is flush with the flanged end of the outer bushing.

14. The fastener assembly of claim 13, wherein the inner bushing is configured to rotate freely relative to the outer bushing when the fastener cap is flush with the flanged end of the outer bushing.
